(19) United States
(12) Patent Application Publication
(10) Pub. No.: US 2014/0278905 A1
(43) Pub. Date: Sep. 18, 2014

(54) TRANSACTION MANAGEMENT

(71) Applicant: 1CARD INC., Chicago, IL (US)

(72) Inventor: Richard Joseph DeNardis, Chicago, IL (US)

(73) Assignee: 1CARD INC., Chicago, IL (US)

(21) Appl. No.: 13/804,971

(22) Filed: Mar. 14, 2013

(51) Int. Cl. G06Q 20/40

(52) U.S. Cl. CPC G06Q 20/405
USPC 705/14.38

(57) ABSTRACT

Transaction management includes receiving a customer identifier and information for a purchase transaction via a network that interfaces with a point of purchase. The customer identifier is associated with identification information for financial accounts and offers. The transaction management also includes accessing a customer account via the customer identifier, retrieving vendor access information, and accessing customer information from a data source of a vendor. The customer information includes at least two of: an accrued rewards benefit, gift card balance, currently offered discount and rebate for a good or service, currently offered discount and rebate for the vendor, interest rate on a lender-issued account, and balance on a payment card account. The transaction management further includes applying rules to the information for the purchase transaction and the financial accounts and offers. The rules calculate a payment function that results in a greatest economic benefit to a customer associated with the customer identifier.

### BACKGROUND

The invention relates to data processing, and more specifically, to transaction management of purchases and related information.

Consumers are oftentimes inundated with offers and incentives from merchants enticing the consumers to initiate purchases using techniques, such as electronic marketing campaigns (e.g., through email communications, text messages and website and mobile display advertising), direct mail, free standing inserts, daily deals and in-store promotions. In addition, many consumers hold multiple credit cards, debit cards, loyalty cards, stored value cards and the like for a number of vendors, each of which provides varying economic benefits including, but not limited to, loyalty points, discounts and access to promotional offers and with varying economic costs (e.g., interest rates and credit limits).

When a consumer is preparing to make a purchase, it can be unclear to the consumer which payment source to use for the specific purchase transaction (e.g., coupon with private label store credit card, general-purpose credit card with rewards, etc.). In part, this is because each of these payment sources may offer different features that in turn result in certain advantages and disadvantages to the consumer with respect to the purchase. In addition, the consumer may be unaware of a discount provided by a merchant or may have neglected to bring to the store coupons or printed daily deal receipts previously mailed or provided to, or acquired by, the consumer. Moreover, it can be inconvenient (and perhaps unsafe) for the consumer to carry multiple payment cards, coupons and offers, many of which, if lost or stolen, cease to provide economic benefit to the consumer.

What is needed, therefore, is a way to simplify the purchasing activities between a consumer and a merchant.

### SUMMARY

According to one embodiment of the invention, a method is provided that includes receiving, by an application executable by a computer processor, a unique customer identifier and information for a purchase transaction via a network. The network interfaces with a point of purchase, and the unique customer identifier is associated with identification information for each of a plurality of financial accounts and offers. The method also includes accessing, by the computer processor, a customer account via the unique customer identifier, retrieving vendor access information for a vendor from the customer account, and accessing customer information from a data source of the vendor via the vendor access information. The customer information includes at least two of: an accrued rewards benefit, a gift card balance, a currently offered discount for a good or service subject to the purchase transaction, a currently offered rebate for a good or service subject to the purchase transaction, a currently offered discount for the vendor, a currently offered rebate for the vendor, an interest rate on a lender-issued account, a balance on a debit account, an available balance on a credit account, and a balance on a prepaid account. The method further includes applying a set of rules to the information for the purchase transaction and the plurality of financial accounts and offers. The set of rules calculate a payment function that results in a greatest economic benefit to a customer associated with the unique customer identifier. The economic benefit includes cost savings and applied vendor-related benefits. The method further includes implementing the payment function responsive to the applying the set of rules.

According to another embodiment of the invention, a system is provided that includes a computer processor and an application executable by the computer processor. The application is configured to implement a method, which includes receiving a unique customer identifier and information for a purchase transaction via a network. The network interfaces with a point of purchase, and the unique customer identifier is associated with identification information for each of a plurality of financial accounts and offers. The method also includes accessing a customer account via the unique customer identifier, retrieving vendor access information for a vendor from the customer account, and accessing customer information from a data source of the vendor via the vendor access information. The customer information includes at least two of: an accrued rewards benefit, a gift card balance, a currently offered discount for a good or service subject to the purchase transaction, a currently offered rebate for a good or service subject to the purchase transaction, a currently offered discount for the vendor, a currently offered rebate for the vendor, an interest rate on a lender-issued account, a balance on a debit account, an available balance on a credit account, and a balance on a prepaid account. The method further includes applying a set of rules to the information for the purchase transaction and the plurality of financial accounts and offers. The set of rules calculate a payment function that results in a greatest economic benefit to a customer associated with the unique customer identifier. The economic benefit includes cost savings and applied vendor-related benefits. The method further includes implementing the payment function responsive to the applying the set of rules.

According to further embodiment of the invention, a computer program product is provided. The computer program product including a storage medium encoded with computer-readable program code, which when executed by a computer, cause the computer to implement a method. The method includes receiving a unique customer identifier and information for a purchase transaction via a network. The network interfaces with a point of purchase, and the unique customer identifier is associated with identification information for each of a plurality of financial accounts and offers. The method also includes accessing a customer account via the unique customer identifier, retrieving vendor access information for a vendor from the customer account, and accessing customer information from a data source of the vendor via the vendor access information. The customer information includes at least two of: an accrued rewards benefit, a gift card balance, a currently offered discount for a good or service subject to the purchase transaction, a currently offered rebate for a good or service subject to the purchase transaction, a currently offered discount for the vendor, a currently offered rebate for the vendor, an interest rate on a lender-issued account, a balance on a debit account, an available balance on a credit account, and a balance on a prepaid account. The method further includes applying a set of rules to the information for the purchase transaction and the plurality of financial accounts and offers. The set of rules calculate a payment function that results in a greatest economic benefit to a customer associated with the unique customer identifier. The economic benefit includes cost savings and applied vendor-related benefits. The method further includes implementing the payment function responsive to the applying the set of rules.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a system upon which transaction management processes may be implemented in accordance with an embodiment of the invention;

FIG. 2 depicts a flow diagram of a process for implementing transaction management according to an embodiment of the invention;

FIG. 3 depicts a customer account record that is linked to vendor-managed customer data in accordance with an embodiment of the invention;

FIGS. 4A-4B depict flow diagrams of a sample process for determining a payment function in accordance with an embodiment of the invention; and

FIG. 5 depicts a user interface for managing customer account information in accordance with an embodiment of the invention.

### DETAILED DESCRIPTION

Exemplary embodiments provide transaction management services. The transaction management services include a payment platform with rules configured to provide economic benefits to customers and reduce processing and marketing costs for merchants or vendors. Customers can manage their accounts through a single interface provided by an enterprise hosting the transaction management services. Account management functions include one or more of the following, but are not limited to, monitoring balances and spending habits, tracking and utilizing points and gift cards, digital coupon delivery, and payment card recommendations. Transaction management activities are enabled through various communications technologies including one or more of the following, but not limited to, near field communication (NFC), barcode scanning, quick response (QR) code scanning or magnetic stripe. These, and other, features of the transaction management processes will now be described.

It is understood in advance that although this disclosure includes a description of a client/server architecture, implementation of the teachings recited herein are not limited to a client/server environment. Rather, embodiments of the invention are capable of being implemented in conjunction with any other type of computing environment now known or later developed. By way of non-limiting example, the invention may be implemented via a cloud computing architecture. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

Turning now to FIG. 1, a system 100 upon which the transaction management processes may be implemented will now be described in an exemplary embodiment.

The system 100 includes a host system computer 102 and a point of purchase system 104 communicatively coupled to one or more networks 106. The host system computer 102 may be implemented as a high-speed computer processing device for handling the volume of activities associated with users of the transaction management processes. In an embodiment, the host system computer 102 is operated by a service provider enterprise.

The point of purchase system 104 may be operated by any individual or entity that offers goods and/or services to customers. The point of purchase system 104 may include one or more computer processors and may include, but is not limited to, elements such as monitor, a printer (e.g., for receipts), a scanner device (e.g., barcode or quick response code reader), and a card reader (debit and/or credit). The system 104 may include point of sale software that performs a variety of functions in addition to purchases, including but not limited to returns, exchanges, gift card issuance, loyalty program maintenance and coupon, discount program and promotions management. The point of purchase system 104 may be implemented at a brick and mortar facility (e.g., retail store) or may be a virtual establishment that is accessed by customers via the Internet.

In an embodiment, the point of purchase system 104 is implemented at a retail establishment. The point of purchase system 104 may be communicatively coupled to a storage device 114, which may be a proprietary data store of the retail establishment. The storage device 114 stores customer information for consumers who shop at the retail establishment. This information may include one or more of the following, but is not limited to, credit features (e.g., a private label store card), loyalty or rewards features (e.g., corresponding offers/incentives for volume or frequent purchases), discounts or promotional offers. While the storage device 114 is shown as coupled to the point of purchase system 104 in a direct fashion, it will be understood that the storage device 114 may be remotely located from the point of purchase system 104 and accessible to the system 104 over one or more networks, such as networks 106.

Also shown in FIG. 1 are computer devices 108, each of which is communicatively coupled to the network(s) 106 and operated by various respective entities, including, but not limited to, vendors (e.g. gift card program manager), financial institutions, and banks. The vendors may also include various merchants that provide goods and services to customers. In an embodiment, the vendors may also include government agencies (e.g., food stamp program), healthcare entities (e.g., health savings accounts), and/or social networks (e.g., linking loyalty or reward points earned via the social network, such as through earned credits, or gift cards offered through the social network). With regard to the financial institutions, the customer may hold one or more accounts (e.g., checking, prepaid, credit card) with the institutions. The computer devices 108 may be implemented using any high-speed computer processing devices (e.g., mainframe computers and/or servers) capable of handling a volume of activities conducted between the computer devices 108 and other desired network entities (e.g., the host system computer 102).

In addition, a user system 118 is included in the system 100 of FIG. 1. The user system 118 is communicatively coupled to the network(s) 106 and may be operated by a customer or end user of the transaction management services. In one embodiment, the user system 118 is implemented as a general-purpose computer (e.g., personal computer or laptop). However, it will be understood that other types of electronic devices may be used to implement the user system 118. For example, the user system 118 may be a mobile device, such as a smart phone, personal digital assistant, or tablet PC. In one embodiment, the user may access a website of the transaction management services that is provided by the host system computer 102 in order to establish a customer account, view existing customer account details, and perform related tasks. A sample user interface screen provided by the website is shown generally in FIG. 5, and is described further herein.

The system 100 of FIG. 1 also includes a storage device 112 communicatively coupled to the host system computer 102. The storage device 112 may be implemented using a variety of devices for storing electronic information. It is understood that the storage device 112 may be implemented using memory contained in the host system computer 102 or it may be a separate physical device, as illustrated in FIG. 1. The storage device 112 may be logically addressable as a consolidated data source across a distributed environment that includes the network(s) 106. Information stored in the storage device 112 may be retrieved and manipulated via the host system computer 102 and any other authorized users. The storage device 112 houses customer accounts, vendor information (e.g., merchant identifiers and financial institution identifiers of the entities operating computer devices 108), and rules that are accessed by the host system computer 102, among other information desired by the enterprise implementing the host system computer 102. The customer accounts stored in storage device 112 are distinguishable from the customer information stored in storage device 114. In particular, the customer accounts reflect accounts established between the service provider of the host system computer 102 and the customer, while the customer information stored in storage device 114 reflects information established between a merchant or vendor associated with the point of purchase system 104 (e.g., a retail establishment) and the customer. In an embodiment, the host system computer 102 operates as a database server and coordinates access to application data including data stored on storage device 112.

The network(s) 106 may be any type of known networks including, but not limited to, a wide area network (WAN), a local area network (LAN), a global network (e.g. Internet), and an intranet. The network(s) 106 may be implemented to include wireless networking technologies or any kind of physical network implementation known in the art. The point of purchase system 104, computer devices 108, and user system 118 may be coupled to the host system computer 102 through multiple networks (e.g., Internet, intranet, and private network) so that not all systems are coupled to the host system computer 102 through the same networks.

In an exemplary embodiment, the host system computer 102 executes an application 110 for implementing the transaction management activities described herein.

The transaction management services include associating a unique identifier with each customer through, e.g., a registration process via the interface. The application 110 generates a customer account that is accessible via the unique customer identifier. As shown in FIG. 1, a unique customer identifier 116 associated with a customer is provided at the point of purchase system 104 for initiating a purchase. The unique customer identifier 116 may be recorded on one or more media, which could include, but is not limited to, a physical card or a storage medium, such as the customer's mobile device or computer (e.g., user system 118). In an embodiment, when the customer initiates a purchase transaction, e.g., by swiping the magnetic strip on a card (which stores the identifier 116) at the point of purchase system 104 or by entering the unique customer identifier 116 at a website (e.g., via a shopping cart function) of a merchant (e.g., one of the computer devices 108), the unique customer identifier 116 is forwarded by the point of purchase system 104 (or alternatively, by the computer device 108 through which the customer has initiated a purchase) onto the host system computer 102 via the network(s) 106. In an alternative embodiment, if the unique customer identifier 116 is stored on the customer's mobile device (e.g., user system 118), the unique customer identifier 116 may be transmitted to the point of purchase system 104 using, e.g., NFC, barcode scanning, or quick response (QR) code scanning, and the point of purchase system 104 then forwards the unique customer identifier 116 to the host system computer 102.

Turning now to FIG. 2, a flow diagram describing a process for implementing the transaction management services will now be described in an embodiment. The process described in FIG. 2 assumes that a customer (e.g., via user system 118) is a registered member of the transaction management services, a customer account has been generated, and a unique customer identifier 116 has been issued for the customer. A sample customer account record is shown and described in FIG. 3. In one non-limiting embodiment, various vendors (e.g., enterprises operating the computer devices 108 and point of purchase system 104) may have agreed to participate in the features provided by the transaction management services. Information relating to these agreements may be stored in storage device 112 as part of the vendor information.

Once the point of purchase system 104 has received the unique customer identifier 116, the point of purchase system 104 forwards the identifier 116, along with purchase transaction information, to the host system computer 102. The purchase transaction information may include one or more of: a transaction identifier that uniquely identifies the particular purchase transaction, a merchant identifier that identifies the merchant for which a purchase transaction is initiated, an item identifier that identifies the good or service subject to the purchase transaction and a cost of the good or service subject to the purchase transaction.

At step 202, the host system computer 102 receives the unique customer identifier 116 associated with the customer from the point of purchase system 104, along with purchase transaction information (at step 204) from the merchant operating the point of purchase system 104 or, alternatively, from the vendor or merchant associated with one of the computer devices 108 (e.g., if the purchase transaction is conducted through the vendor's website).

At step 206, the application 110 accesses the customer account from the storage device 112 via the unique customer identifier 116, and retrieves data from the customer account at step 208. As shown in FIG. 3 by way of non-limiting example, a customer account record 300A provides the unique customer identifier 302 (116), vendor identification information 304, and vendor access information 306, for each vendor (e.g., a vendor associated with the point of purchase system 104, as well as vendors operating the computer devices 108) associated with the customer. For example, if the customer has accounts with multiple vendors, each vendor is represented in record 300A (e.g., as VENDOR1 ID, VENDOR2 ID, . . . , VENDORn ID). The vendor access information 306 includes information that enables the application 110 to access particular information about the customer that is stored and managed by the vendor (or alternatively, by a third-party provider that maintains this information on behalf of a vendor) and may otherwise be accessible only to the customer. For example, if the customer has a private label credit card with the vendor operating the point of purchase system 104, the customer information accessed by the application 110 from the storage device 114 (or alternatively, another data repository storing the customer information that is maintained by a third party on behalf of the vendor) may include a current balance, available credit, a credit limit, and the annual percentage rate for the customer's credit. Other information may be accessed as well, such as any accrued or available points provided by the vendor. Thus, at step 209, the application 110 accesses customer information managed by the vendor (e.g., VENDOR1 ID) via the vendor access information 306. The vendor access information 306 may include, but is not limited to, a secure network address, account number, user ID and password, or other credentials authorized by the customer for purposes of obtaining information managed by the respective vendor. As shown in FIG. 3, the record 300A provides the vendor access information 306 that is utilized by the application 110 to access a customer information record 300B managed by the vendor for the particular customer. The customer information record 300B may include items 308, for example, an account type (e.g., debit, credit, etc.), balance information, rewards information, loyalty account information, discount information, and coupon information, among other desired information.

Returning to FIG. 2, at step 210, the application 110 applies one or more rules to the purchase transaction information and the customer information associated with each of the vendors (e.g., information related to financial accounts and offers that are associated with the unique customer identifier 116). In an embodiment, the rules are retrieved from the storage device 112 and are automatically applied to the purchase transaction information and financial accounts/offers absent any intervention on behalf of the customer. The rules may be configured by the service provider of the host system computer 102 to provide the greatest economic benefit to the customer, such benefit including, but not limited to, the greatest amount of cost savings and/or vendor-related benefit to the customer. For example, if the point of purchase system 104 is a gas station, and the customer is purchasing gas, the application 110 may look for electronic coupons for the vendor (e.g., via the merchant identifier), features associated with a general credit card (e.g., where the credit card service offers cash back on gas purchases), available credit limits on the customer's credit cards, interest rates charged on the customer's credit cards, and any other reward or benefit available that may relate to the particular purchase.

At step 212, the application 110 determines a payment function resulting from application of the rules and, at step 214, the application 110 implements the payment function and updates the customer account in the storage device 112. The payment function specifies which of the sources of payment will be used to execute payment for the purchase and, if multiple offers exist, which of the offers will result in the greatest economic benefit to the customer.

Steps 210, 212, and 214 may include an iterative process whereby the application 110 looks to a first type of account or payment option to complete the purchase, and if not fully satisfied by the first type of account, looks to a second type of account or payment option. As shown in FIGS. 4A-4B, a flow diagram of a non-limiting sample process for determining a payment function at a point of purchase in accordance with an embodiment of the invention will now be described. While the process of FIGS. 4A-4B is described with steps occurring in a particular order, the embodiments are not so limited. It will be understood that any variation in the order of the following steps may be implemented in order to realize the advantages of the embodiments of the invention.

At step 402, the application 110 receives the unique customer identifier 116 and an authorization request from a merchant (e.g., via the point of purchase system 104). The authorization request may include a unique transaction identifier and purchase information, such as an amount of the purchase.

At step 404, the application 110 determines whether a coupon is available for the purchase. If so, the application 110 deducts the coupon amount from the amount of the purchase at step 406, and marks the coupon as redeemed at step 408. A coupon may be determined to be available if the customer has selected it, for example, via the interface of the application 110 (see, e.g., section 504 of the interface 500 of FIG. 5) or through a vendor's website. The coupon may be marked as redeemed via a message transmitted by the application 110 to the vendor.

In one embodiment, the application 110 may be configured to allow the customer to override the automated payment function described herein. In this embodiment, once the coupon has been redeemed at step 408, (or alternatively, if no coupon is available at step 404), at step 410 the application 110 determines if the customer has selected an override function. The override function, once enabled, allows the customer to determine how he/she will pay for the purchase. The override function may be implemented, e.g., through a shopping cart function if the purchase is performed online. In one embodiment, the transaction management services may provide a mobile application for the customer's mobile device that includes an option configured to enable the customer to override the automated payment functions described herein and to select a particular payment source for the purchase transaction. For example, if the customer is physically present the point of purchase system 104 (e.g., a check-out register), the customer may access the mobile application on the mobile device (e.g., the user system 118) and select the override function along with a source of payment (e.g., a general-purpose credit card), which in turn, is transmitted over the network(s) 106 to the host system computer 102.

If the customer has selected the override function, the application 110 next determines if the account associated with the selected payment source has enough funds or balance availability to cover the purchase amount at step 412. If so, the purchase is executed through the selected account at step 414 and an authorization approval is transmitted to the merchant at step 415. Otherwise, if the user has not selected the override function (step 410) or there are insufficient funds (or credit availability) in the customer's selected account (step 412), the application 110 determines whether a gift card for the merchant is available at step 416 and, if not, the process proceeds to step 426. However, if a gift card is available at step 416, the application 110 determines whether the gift card balance is greater than the purchase amount (minus any deducted coupons from step 406 or funds applied from the selected account (step 412)) at step 418. If so, the application 110 transmits a debit authorization request to the gift card balance maintained at the merchant or a third party vendor (e.g., one of computer devices 108) at step 420. At step 422, the application 110 sends a message to the point of purchase system 104 indicating that the purchase transaction has been approved. In one embodiment, the application 110 may also send additional information to the point of purchase system 104, such as deducted coupon amounts and gift card deduction amounts.

However, at step 418 if the customer has a gift card but the balance is less than the purchase amount (minus any deducted coupons from step 406 and/or funds applied from the selected account (step 412)), the application 110 transmits a debit request for the gift card balance to the merchant at step 424, and the process proceeds to step 426.

At step 426, the application 110 determines if the customer has a private label (PL) merchant card. If not, the process proceeds to step 436. Otherwise, if the customer has a private label merchant card at step 426, the application 110 determines if merchant card balance (e.g., available credit) is greater than the purchase amount (minus any deducted coupons from step 406, funds applied from the selected account from step 412, and any gift card deductions from step 424) at step 428. If so, the application 110 transmits a post amount to the private label card balance at step 430 and generates a message to the merchant that the authorization is approved at step 432.

Returning to step 428, if the available private label merchant card balance is less than the purchase amount, the application 110 transmits a debit request for the private label merchant card balance to the vendor at step 434, and the process proceeds to step 436.

At step 436, the application 110 determines if the customer has a general purpose gift card (e.g., one that is not associated with the merchant but may be used to purchase items from the merchant). If not, the process proceeds to step 446. Otherwise, if the application 110 determines that the customer has a general purpose gift card at step 436, the application 110 then determines if the general purpose gift card balance is greater than the purchase amount (minus any deducted coupons and merchant gift card amounts) at step 438. If so, the application 110 transmits a debit request for the gift card balance to the vendor maintaining the gift card at step 440 and generates a message to the merchant that the authorization is approved at step 442.

Returning to step 438, if the general purpose gift card balance is not greater than the purchase amount (minus any deducted coupons and merchant gift card amounts), the application 110 transmits a debit request for the general purpose gift card balance to the vendor at step 444 and the process proceeds to step 446.

At step 446, the application 110 determines if the customer's available credit for a general purpose credit card is greater than the purchase amount (minus any deducted coupons and merchant/general purpose gift card amounts). Alternatively, the application 110 may determine if there are sufficient funds in the customer's general purpose debit account or prepaid account. If not, the purchase is declined at step 452. Otherwise, the application 110 transmits a post amount to the general purpose credit card balance (or, as applicable, to the general purpose debit account or prepaid account) at step 448 and generates authorization to merchant to accept the purchase at step 450.

As indicated above, the transaction management services enable a customer to view, track, and manage account information via an interface provided, e.g., via the application 110. A user interface screen 500 illustrated in FIG. 5 will now be described by way of non-limiting example.

The interface screen 500 includes a section 502 that provides current account information, such as balances and points earned/used with respect to a selected vendor. In a second section 504, the customer is provided with options to access other functions, such as trading a gift card balance, viewing other card balance information, signing up for and viewing merchant and manufacturer coupons. It will be understood that any other type of functions may be provided through this section 504.

Technical effects include a payment platform with rules configured to increase savings to customers and reduce processing and marketing costs for merchants or vendors. Customers can manage their accounts through a single interface provided by an enterprise hosting the transaction management services. Account management functions include, e.g., monitoring balances and spending habits, tracking and utilizing points and gift cards, digital coupon delivery, and card recommendations. Transaction management activities are enabled through various communications technologies, such as near field communication (NFC), barcode scanning, quick response (QR) code scanning or a magnetic stripe.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java, HTML, JavaScript, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus to provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to the diagrams or the steps (or operations) described therein without departing from the spirit of the invention. For instance, the steps may be performed in a differing order or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method, comprising:
receiving, by an application executable by a computer processor, a unique customer identifier and information for a purchase transaction via a network, the network interfacing with a point of purchase, and the unique customer identifier being associated with identification information for each of a plurality of financial accounts and offers;
accessing, by the computer processor, a customer account via the unique customer identifier;
retrieving vendor access information for a vendor from the customer account;
accessing customer information from a data source of the vendor via the vendor access information, the customer information including at least two of: an accrued rewards benefit, a gift card balance, a currently offered discount for a good or service subject to the purchase transaction, a currently offered rebate for a good or service subject to the purchase transaction, a currently offered discount for the vendor, a currently offered rebate for the vendor, an interest rate on a lender-issued account, a balance on a debit account, an available balance on a credit account, and a balance on a prepaid account;
applying a set of rules to the information for the purchase transaction and the plurality of financial accounts and offers, the set of rules calculating a payment function that results in a greatest economic benefit to a customer associated with the unique customer identifier, the economic benefit including cost savings and applied vendor-related benefits; and
implementing the payment function responsive to the applying the set of rules.

2. The method of claim 1, wherein the applying the set of rules and the implementing the payment function are automatically performed at the point of purchase and absent intervention by the customer.

3. The method of claim 1, wherein the applying the set of rules includes:
identifying a coupon associated with the good or service; and
deducting an amount specified by the coupon from a cost of the good or service before examining another source for implementing the payment function.

4. The method of claim 1, wherein the applying the set of rules includes:
identifying a gift card associated with the vendor and the customer; and
deducting an amount specified by a balance of the gift card from the cost of the good or service.

5. The method of claim 1, wherein the applying the set of rules includes:
identifying a private label credit card associated with the vendor and the customer; and
deducting an amount specified by a balance of the private label credit card from the cost of the good or service.

6. The method of claim 1, wherein the applying the set of rules includes:
identifying at least one of a general purpose credit card, general purpose debit card, and a prepaid card associated with the customer; and
deducting an amount specified by a balance of the at least one general purpose credit card, general purpose debit card, and prepaid card from the cost of the good or service.

7. The method of claim 1, wherein the unique customer identifier is incorporated into at least one of a:
physical card; and
digital storage medium.

8. The method of claim 1, wherein the customer information includes an account identifier established between the customer and the vendor in response to authorization provided by the customer to the vendor.

9. A system, comprising:
a computer processor; and
an application executable by the computer processor, the application implementing a method, the method comprising:
receiving a unique customer identifier and information for a purchase transaction via a network, the network interfacing with a point of purchase, and the unique customer identifier being associated with identification information for each of a plurality of financial accounts and offers;
accessing a customer account via the unique customer identifier;
retrieving vendor access information for a vendor from the customer account;
accessing customer information from a data source of the vendor via the vendor access information, the customer information including at least two of: an accrued rewards benefit, a gift card balance, a currently offered discount for a good or service subject to the purchase transaction, a currently offered rebate for a good or service subject to the purchase transaction, a currently offered discount for the vendor, a currently offered rebate for the vendor, an interest rate on a lender-issued account, a balance on a debit account, an available balance on a credit account, and a balance on a prepaid account;
applying a set of rules to the information for the purchase transaction and the plurality of financial accounts and offers, the set of rules calculating a payment function that results in a greatest economic benefit to a customer associated with the unique customer identifier, the economic benefit including cost savings and applied vendor-related benefits; and
implementing the payment function responsive to the applying the set of rules.

10. The system of claim 9, wherein the applying the set of rules and the implementing the payment function are automatically performed at the point of purchase and absent intervention by the customer.

11. The system of claim 9, wherein the applying the set of rules includes:
identifying a coupon associated with the good or service; and
deducting an amount specified by the coupon from a cost of the good or service before examining another source for implementing the payment function.

12. The system of claim 9, wherein the applying the set of rules includes:
identifying a gift card associated with the vendor and the customer; and
deducting an amount specified by a balance of the gift card from the cost of the good or service.

13. The system of claim 9, wherein the applying the set of rules includes:
identifying a private label credit card associated with the vendor and the customer; and
deducting an amount specified by a balance of the private label credit card from the cost of the good or service.

14. The system of claim 9, wherein the applying the set of rules includes:
identifying at least one of a general purpose credit card, general purpose debit card, and a prepaid card associated with the customer; and
deducting an amount specified by a balance of the at least one general purpose credit card, general purpose debit card, and prepaid card from the cost of the good or service.

15. The system of claim 9, wherein the unique customer identifier is incorporated into at least one of a:
physical card; and
digital storage medium.

16. The system of claim 9, wherein the customer information includes an account identifier established between the customer and the vendor in response to authorization provided by the customer to the vendor.

17. A computer program product comprising a non-transitory computer-readable storage medium having instructions embodied thereon, which when executed by a computer processor, cause the computer processor to implement a method, the method comprising:
receiving a unique customer identifier and information for a purchase transaction via a network, the network interfacing with a point of purchase, and the unique customer identifier being associated with identification information for each of a plurality of financial accounts and offers;
accessing a customer account via the unique customer identifier;
retrieving vendor access information for a vendor from the customer account;
accessing customer information from a data source of the vendor via the vendor access information, the customer information including at least two of: an accrued rewards benefit, a gift card balance, a currently offered discount for a good or service subject to the purchase transaction, a currently offered rebate for a good or service subject to the purchase transaction, a currently offered discount rebate for the vendor, a currently offered rebate for the vendor, an interest rate on a lender-issued account, a balance on a debit account, an available balance on a credit account, and a balance on a prepaid account;
applying a set of rules to the information for the purchase transaction and the plurality of financial accounts and offers, the set of rules calculating a payment function that results in a greatest economic benefit to a customer associated with the unique customer identifier, the economic benefit including cost savings and applied vendor-related benefits; and
implementing the payment function responsive to the applying the set of rules.

18. The computer program product of claim 17, wherein the applying the set of rules and the implementing the payment function are automatically performed at the point of purchase and absent intervention by the customer.

19. The computer program product of claim 17, wherein the applying the set of rules includes:
identifying a coupon associated with the good or service; and
deducting an amount specified by the coupon from a cost of the good or service before examining another source for implementing the payment function.

20. The computer program product of claim 17, wherein the applying the set of rules includes:
identifying a gift card associated with the vendor and the customer; and
deducting an amount specified by a balance of the gift card from the cost of the good or service.

21. The computer program product of claim 17, wherein the applying the set of rules includes:
identifying a private label credit card associated with the vendor and the customer; and
deducting an amount specified by a balance of the private label credit card from the cost of the good or service.

22. The computer program product of claim 17, wherein the applying the set of rules includes:
identifying at least one of a general purpose credit card, general purpose debit card, and a prepaid card associated with the customer; and
deducting an amount specified by a balance of the at least one general purpose credit card, general purpose debit card, and prepaid card from the cost of the good or service.

23. The computer program product of claim 17, wherein the unique customer identifier is incorporated into at least one of a:
physical card; and
digital storage medium.

24. The computer program product of claim 17, wherein the customer information includes an account identifier established between the customer and the vendor in response to authorization provided by the customer to the vendor.
